(19) United States
(12) Patent Application Publication
(10) Pub. No.: US 2009/0024382 A1
(43) Pub. Date: Jan. 22, 2009

(54) LANGUAGE INFORMATION SYSTEM

(76) Inventor: Barend P. Wolvaardt, Perth (AU)

Correspondence Address: STITES & HARBISON PLLC, 1199 NORTH FAIRFAX STREET, SUITE 900, ALEXANDRIA, VA, 22314, US

(21) Appl. No.: 11/816,875

(22) PCT Filed: Jan. 20, 2006
(86) PCT No.: PCT/IB06/50215

§ 371 Date: Apr. 30, 2008

(30) Foreign Application Priority Data
Mar. 3, 2005 (ZA) 2005/0006

(51) Int. Cl. G06F 17/28

(52) U.S. Cl. 704/2; 704/3

(57) ABSTRACT

The invention discloses a language information system, which includes an original first text of an original first language in electronic format; a second text of a second language in electronic format; first linking means for providing linkages of words of the first text to equivalent words in the second text; second linking means for linking the contextual meaning in a lexicon to the word and/or combination of words in the original first language (or the translated languages); significant meaning indicators adapted to be marked in order to see how the meaning structure of a section of language develops; commenting means to drag and drop comment at any place; electronic storage means for storing at least the texts and the linkages; and a search facility for finding occurrences of a specific theme name or keyword name in relation to the texts. The texts are of a biblical and/or religious nature.

### FIELD OF INVENTION

The present invention relates to a language information system.

More particularly, the present invention relates to a language information system for providing the meaning and translation of text and tools for analysis.

### BACKGROUND TO INVENTION

Language is the method of human communication, either spoken or written, consisting of the use of words in an agreed way. The languages of particular communities or countries differ considerably and worldwide there are thousands of different spoken and written languages.

In order to comprehend a language foreign to one's own language, the foreign text needs to be translated into an understandable language or format. To translate is thus to express the sense of a word, sentence, speech or book into another language. Translation also includes a written or spoken rendering of the meaning of a word, speech, or book on another language.

Many translation means have been developed, though often these do not show the relationship between the different languages or provide the tools to analyse and record the meaning of the text.

It is an object of the invention to suggest a language information system which will assist in overcoming the afore-mentioned problems.

### SUMMARY OF INVENTION

According to the invention, a language information system includes
(a) an original first text of an original first language in electronic format;
(b) a second text of a second language in electronic format; and
(c) linking means for linking the equivalent text and/or word of the first text with the second text.

Also according to the invention, a language information system includes
(a) an original first text of an original first language in electronic format;
(b) a second text of a second language in electronic format;
(c) first linking means for linking the equivalent text and/or word of the first text with the second text;
(d) second linking means for linking the contextual meaning in a lexicon to the word and/or combination of words in the original first language (or the translated languages);
(e) significant meaning indicators adapted to be marked in order to see how the meaning structure of a section of language develops;
(f) commenting means to drag and drop comments at any place;
(g) electronic storage means for storing at least the texts and the links;
(h) a search facility for finding occurrences of a specific theme name or keyword name in relation to the texts;
(i) export means for exporting analysis of the texts and authored documents to other users; and
(j) meaning structure means for designing the meaning structure of a book and/or document.

The system may include further texts in languages different to the original first language and the second language.

The system may be operated by means of computer hardware and software.

The second text may originally be obtained from the original first text by translation.

A user may select a word and/or a combination of words from the text.

The user may perform the function of selection by means of an input device, such as a computer mouse and cursor.

The system may include a storage database for storing linkages between the various texts.

A linkage may be displayed when the computer mouse cursor touches any word in either the first and or the second text.

Means may be provided for indicating that text/wording occur only in a translation and not in the original language, for example underlining and/or non-underlining and/or bolding and/or italics and/or different font and/or brackets.

The linked text may be exported for use by another user.

The system may link the contextual meaning in a lexicon to the word and/or combination of word in the original language (or the translated languages).

The system may provide a meaning sensitive search of the original language (or the translated languages).

The user may link a word and/or phrase from the original language (or the translated languages) to a lexicon.

The user may select the contextual meaning from a lexicon.

The lexicon may provide a range of possible meanings of a word and/or phrase.

The link and selection may be stored in a database.

A search facility may be provided to find the occurrences of a specific meaning in the text(s).

The system may provide a step by step process by which a section of a language can be analysed to understand its meaning structure.

A passage may be displayed line by line to simplify analysis and corn prehension.

The system may be provided with a number of significant meaning indicators.

The meaning indicators may be marked in order to see how the meaning structure of a section of language develops.

The description of the meaning indicator(s) may be listed and linked to each occurrence.

The meaning structure may be displayed.

The title and description of the meaning structure may be listed and linked to its occurrence.

The system may include commenting means to drag and drop comments at any place.

The commenting means and/or comments may be given a theme name or key word name.

The commenting means and/or comments may be stored in a database.

A search facility may be provided by which the user can find all the occurrences of a specific theme name or keyword name.

The user may author, store and search documents like research papers, devotions, sermon outlines and/or discussion questions based on the text analysis

The analysis and authored documents may be exported to other users via the internet and e-mail.

The meaning structure of a whole book may be designed and displayed.

The historical background information of the book may be stored and presented and/or displayed.

The texts may be of a biblical and/or religious nature.

The texts may include passages of The Bible.

The texts may consist exclusively of The Bible.

### BRIEF DESCRIPTION OF DRAWINGS

The invention will now be described by way of example with reference to the accompanying schematic drawings.

In the drawings there is shown in:

FIG. 1: a first screenshot of the system in accordance with the invention illustrating the first linking means;

FIG. 2: a second screenshot of the system in accordance with the invention illustrating the first linking means;

FIG. 3: a third screenshot of the system in accordance with the invention illustrating the second linking means;

FIG. 4: a fourth screenshot of the system in accordance with the invention illustrating the second linking means;

FIG. 5: a fifth screenshot of the system in accordance with the invention illustrating the step by step language analysis process;

FIG. 6: a sixth screenshot of the system in accordance with the invention illustrating the significant meaning indicators;

FIG. 7: a seventh screenshot of the system in accordance with the invention illustrating the meaning structure; and

FIG. 8: a eight screenshot of the system in accordance with the invention illustrating the commenting means.

### DETAILED DESCRIPTION OF DRAWINGS

Referring to the drawings, a language information system in accordance with the invention is described.

The language information system includes
(a) original first text of an original first language in electronic format;
(b) second text of a second language in electronic format;
(c) first linking means for linking the equivalent text and/or word of the first text with the second text;
(d) second linking means for linking the contextual meaning in a lexicon to the word and/or combination of words in the original first language (or the translated languages);
(e) significant meaning indicators adapted to be marked in order to see how the meaning structure of a section of language develops;
(f) commenting means to drag and drop comments at any place;
(g) electronic storage means for storing at least the texts and the links;
(h) a search facility for finding occurrences of a specific theme name or keyword name in relation to the texts;
(i) export means for exporting analysis of the texts and authored documents to other users; and
(j) meaning structure means for designing the meaning structure of a book and/or document.

The system includes further texts in languages different to the original first language and the second language.

The system is operated by means of computer hardware and software.

The second text is originally obtained from the original first text by translation.

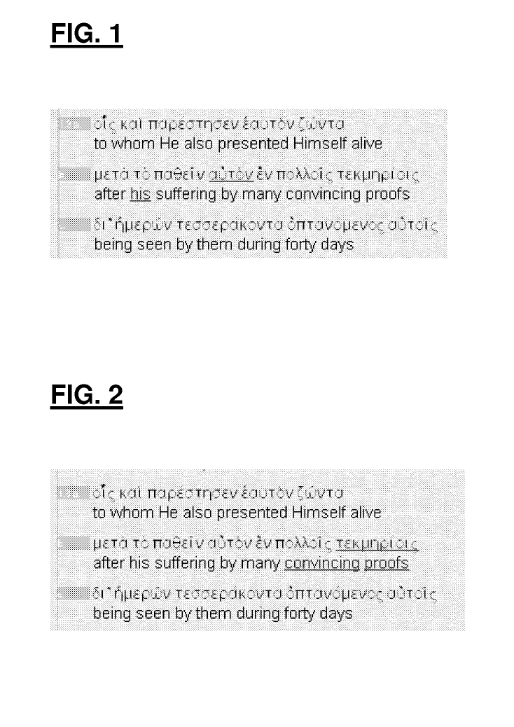

Referring to FIGS. 1 and 2, a user selects a word or a combination of words from the text. The user performs the function of selection by means of an input device, such as a computer mouse and cursor. The system includes a storage database for storing linkages between the various texts.

A linkage is displayed when the computer mouse cursor touches any word in either the first and or the second text. Means are provided for indicating that text/wording occur only in a translation and not in the original language, for example underlining, non-underlining, bolding, italics, brackets and different fonts. The linked text can be exported for use by another user.

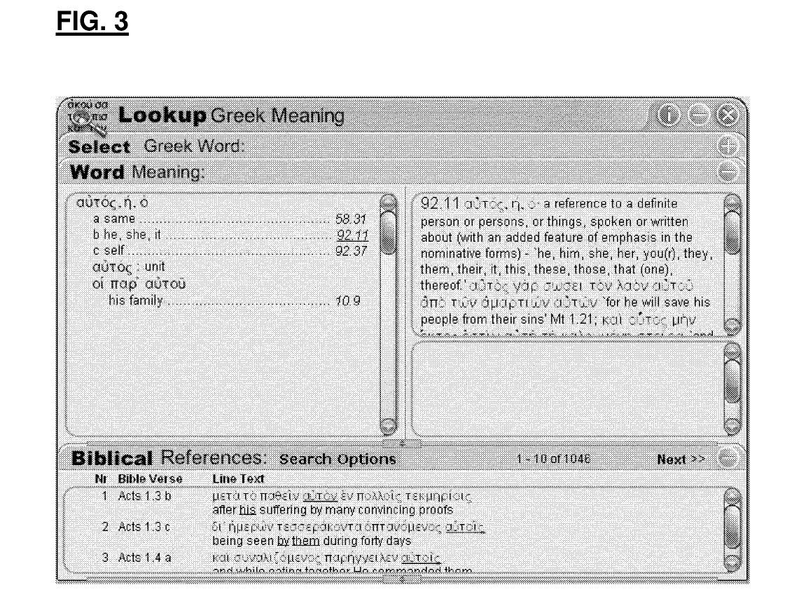

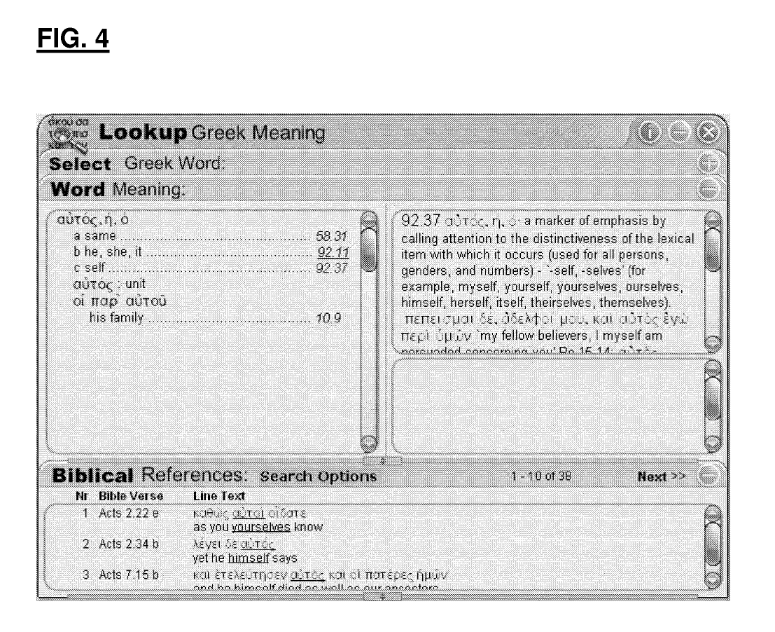

Referring to FIGS. 3 and 4, the system links the contextual meaning in a lexicon to the word or combination of word in the original language (or the translated languages). The system provides a meaning sensitive search of the original language (or the translated languages).

The user links a word and/or phrase from the original language (or the translated languages) to a lexicon. The user selects the contextual meaning from a lexicon. The lexicon provides a range of possible meanings of a word and/or phrase.

The link and selection is be stored in a database. A search facility is provided to find the occurrences of a specific meaning in the texts.

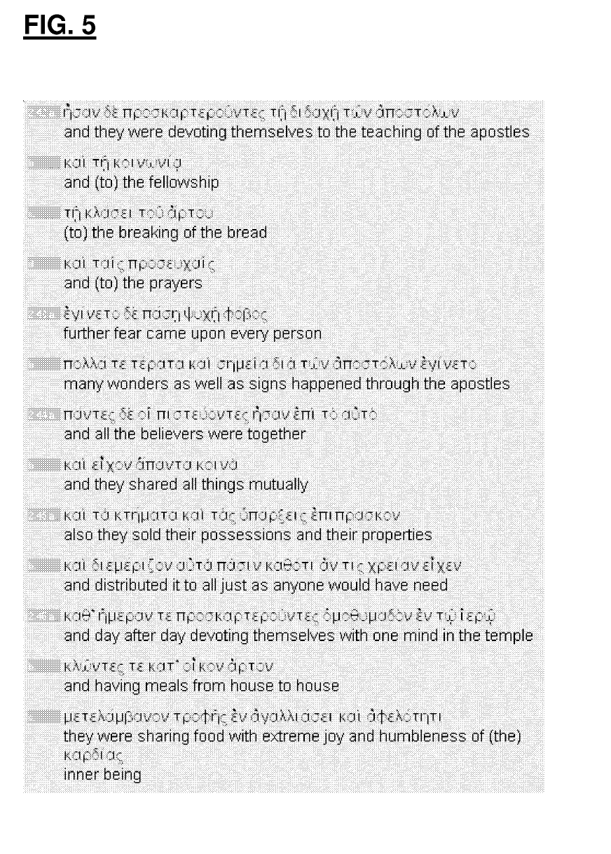

Referring to FIG. 5, the system provides a step by step process by which a section of a language can be analysed to understand its meaning structure. A passage can be displayed line by line to simplify analysis and comprehension.

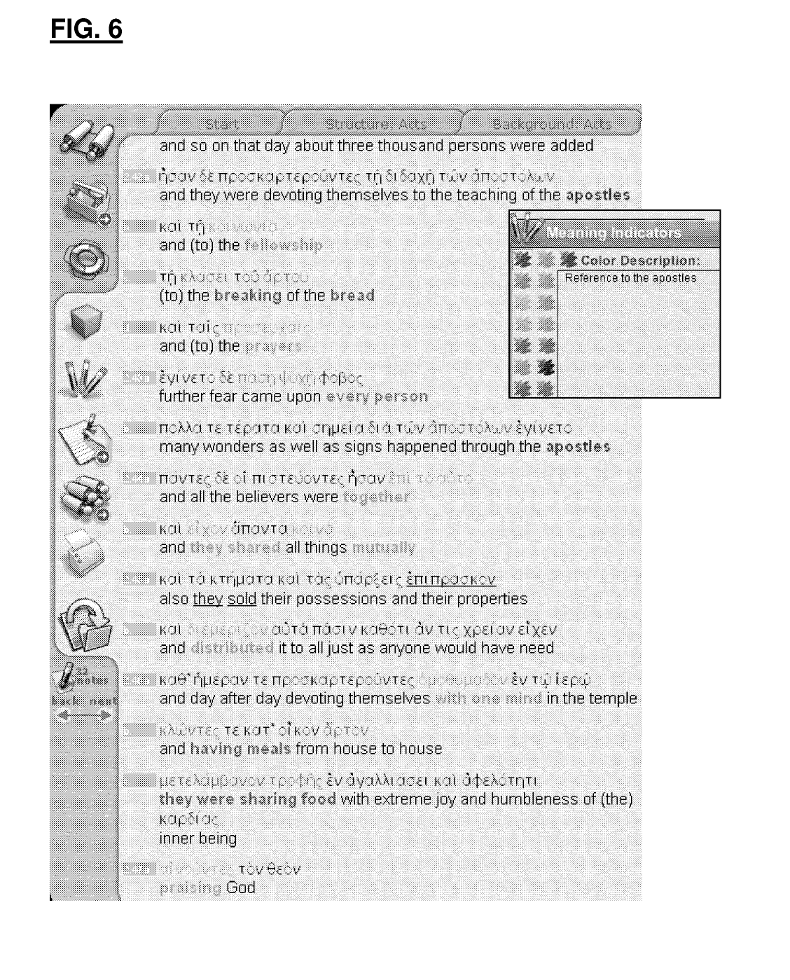

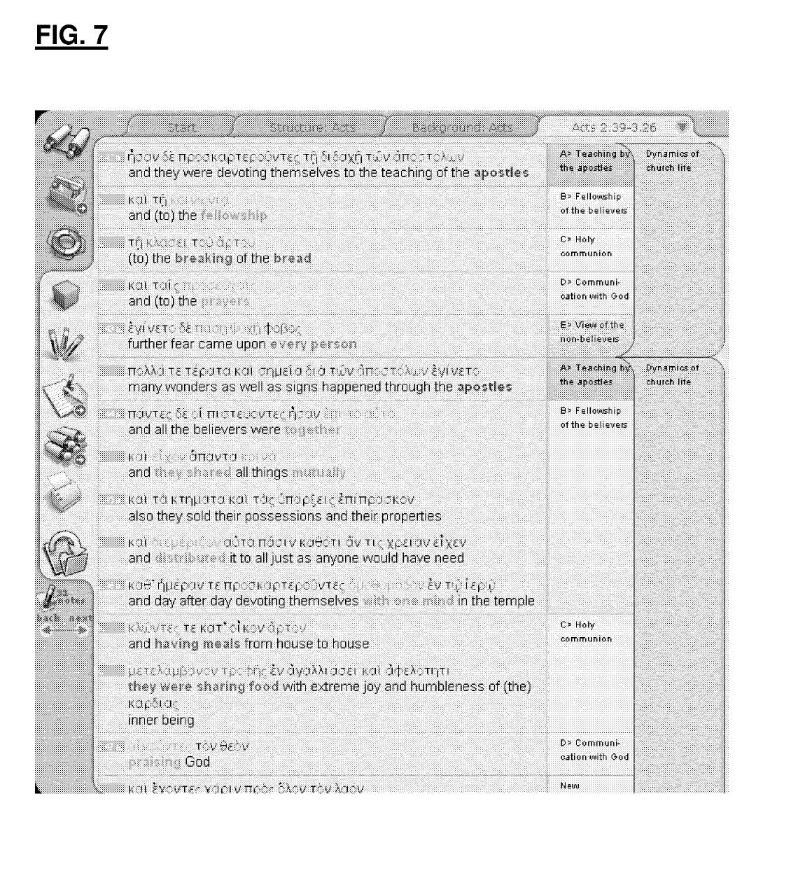

Referring to FIG. 6, the system is adapted to allow the user to identify a number of significant meaning indicators. The meaning indicators are marked in order to see how the meaning structure of a section of language develops. The description of the meaning indicators are listed and linked to each occurrence.

Referring to FIG. 7, the system is adapted to display the meaning structure. The title and description of the meaning structure is listed and linked to its occurrence.

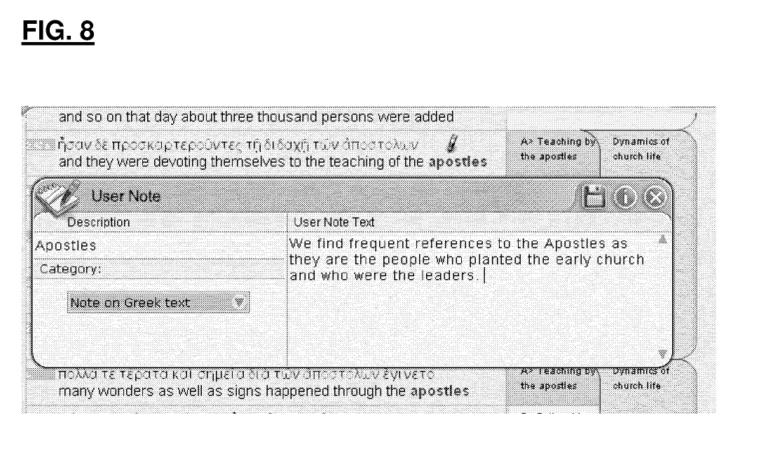

Referring to FIG. 8, the system includes commenting means to drag and drop comments at any place. The commenting means and comments are given a theme name or key word name. The commenting means and comments are stored in a database. A search facility is provided by which the user can find all the occurrences of a specific theme name or keyword name.

The user can thus author, store and search documents such as research papers, devotions, sermon outlines and discussion questions based on the text analysis

The analysis and authored documents can be exported to other users via the internet and e-mail.

The meaning structure of a whole book can be designed and displayed.

The historical background information of the book is stored and presented and displayed.

The texts are generally of a biblical and religious nature, and include passages of The Bible.

1. A language information system, which includes
(a) an original first text of an original first language in electronic format;
(b) a second text of a second language in electronic format; and
(c) linking means for providing linkages of words of the first text to equivalent words in the second text, the linkages being adapted to be displayed when a cursor touches any word in either the first text or the second text.

2. A system as claimed in claim 1, which includes further texts in languages different to the original first language and the second language.

3. A system as claimed in claim 1, which is operable by means of computer hardware and software.

4. A system as claimed in claim 1, in which the second text is originally obtained from the original first text by translation.

5. A system as claimed in claim 1, by means of which a user is able to select a word and/or a combination of words from the first text.

6. A system as claimed in claim 5, by means of which a user is able to perform the function of selection by means of an input device, such as a computer mouse and cursor.

7. A system as claimed in claim 1, which includes a storage means for storing the linkages between the various texts.

8. A system as claimed in claim 1, which includes means for indicating that text/wording occur only in a translation and not in the original language, for example underlining and/or not-underlining and/or bolding and/or italics and/or different font and/or brackets.

9. A system as claimed in claim 1, in which the linked words are adapted to be exported for use by another user.

10. A system as claimed in claim 1, which is adapted to link a contextual meaning in a lexicon to the word and/or combination of words in the original language and/or the translated languages.

11. A system as claimed in claim 1, which is adapted to provide a meaning sensitive search of the original language and/or the translated languages.

12. A system as claimed in claim 1, by means of which a user is able to link a word and/or phrase from the original language (or the translated languages) to a lexicon.

13. A system as claimed in claim 10, by means of which a user is able to select the contextual meaning from a lexicon.

14. A system as claimed in claim 12, in which the lexicon is adapted to provide a range of possible meanings of a word and/or phrase.

15. A system as claimed in claim 12, in which the linkages are adapted to be stored in a database.

16. A system as claimed in claim 13, in which the selected contextual meanings are adapted to be stored in a database.

17. A system as claimed in claim 1, in which a search facility is provided to find the occurrences of a specific meaning in the text(s).

18. A system as claimed in claim 1, which provides a step by step process by means of which a section of a language can be analysed to understand its meaning structure.

19. A system as claimed in claim 1, by means of which a passage is displayed line by line to simplify analysis and comprehension.

20. A system as claimed in claim 1, which is provided with a number of significant meaning indicators.

21. A system as claimed in claim 20, in which the meaning indicators are marked in order to see how the meaning structure of a section of language develops.

22. A system as claimed in claim 20, which includes a description of the meaning indicators.

23. A system as claimed in claim 21, in which the meaning structure is adapted to be displayed.

24. A system as claimed in claim 21, in which the title and description of the meaning structure are listed and linked to its occurrence.

25. A system as claimed in claim 1, which includes commenting means and/or comments to drag and drop comments at any place.

26. A system as claimed in claim 25, in which the commenting means and/or comments are given a theme name and/or key word name.

27. A system as claimed in claim 25, in which the commenting means and/or comments are stored in a database.

28. A system as claimed in claim 1, which includes a search facility by means of which the user can find all the occurrences of a specific theme name or keyword name.

29. A system as claimed in claim 1, which is adapted to enable a user to analyse, author, store and search documents.

30. A system as claimed in claim 29, in which the documents include at least one document selected from the group comprising research papers, devotions, sermon outlines and discussion questions based on the text analysis.

31. A system as claimed in claim 29, in which the documents are adapted to be exported to other users via the internet and e-mail.

32. A system as claimed in claim 21, by means of which the meaning structure of a whole book can be designed and displayed.

33. A system as claimed in claim 1, by means of which historical background information of the texts, the languages and/or a book can be stored, presented and/or displayed.

34. A system as claimed in claim 1, in which the texts are of a biblical and/or religious nature.

35. A system as claimed in claim 1, in which the texts include passages of The Bible.

36. A system as claimed in claim 1, in which the texts consist exclusively of The Bible.

37. A language information system, which includes
(a) an original first text of an original first language in electronic format;
(b) a second text of a second language in electronic format;
(c) first linking means for providing linkages of words of the first text to equivalent words in the second text;
(d) second linking means for linking the contextual meaning in a lexicon to the word and/or combination of words in the original first language (or the translated languages);
(e) significant meaning indicators adapted to be marked in order to see how the meaning structure of a section of language develops;
(f) commenting means to drag and drop comments at any place;
(g) electronic storage means for storing at least the texts and the linkages;
(h) a search facility for finding occurrences of a specific theme name or keyword name in relation to the texts;
(i) export means for exporting analysis of the texts and authored documents to other users; and
(j) meaning structure means for designing the meaning structure of a book and/or document.

38. A language information system substantially as hereinbefore described with reference to the accompanying drawings.
